(19) United States
(12) Patent Application Publication
(10) Pub. No.: US 2018/0095959 A1
(43) Pub. Date: Apr. 5, 2018

(54) LARGE SCALE PROCESSOR FOR SATELLITE DATA

(71) Applicant: General Electric Company, Schenectady, NY (US)

(72) Inventors: Vikas RATHEE, San Ramon, CA (US); Beena AMMANATH, San Ramon, CA (US); Vikram LAKSHMIPATHY, San Ramon, CA (US); Bikram Singh SISODIA, San Ramon, CA (US)

(21) Appl. No.: 15/284,821

(22) Filed: Oct. 4, 2016

(51) Int. Cl. G06F 17/30

(52) U.S. Cl. CPC G06F 17/3028; G06F 17/30091

(57) ABSTRACT

Provided are a system and method for analyzing and processing satellite data having a plurality of formats. In one example, a method includes extracting satellite data from source files that include a plurality of file formats, identifying spatial data and non-spatial data from the extracted satellite data, identifying a point of interest from the spatial data and mapping information for the non-spatial data based on the point of interest, determining time series data corresponding to the point of interest from the non-spatial data based on the mapping information identified from the spatial data, and displaying time series data at the point of interest. According to various embodiments, the method and system are capable of extracting satellite data from files having different file formats and performing analysis on the data regardless of its format.

### BACKGROUND

Satellites provide raw radiance data that is typically collected by ground stations and archived for image analysis by databases therein. Satellites can provide continuous global environmental observations which may be analyzed to produce various geophysical variables to describe the Earth's atmospheric, oceanic, and terrestrial domains. For example, geostationary satellites help monitor and predict weather and environmental events including hurricanes, tropical systems, tornadoes, flash floods, dust storms, volcanic eruptions, and forest fires. As another example, polar-orbiting satellites collect data related to weather, climate, and environmental monitoring applications including rain precipitation, sea surface temperatures, atmospheric temperature and humidity, sea ice extent, forest fires, volcanic eruptions, global vegetation analysis, as well as search and rescue operations. Other types of satellites provide data for industries such as geo-navigation, communications, astronomy, space exploration, and the like. Satellite data can improve the Earth's resilience to climate variability, maintain economic vitality, and improve the security and well-being of the public.

Satellite data is available in different formats, resolutions, and levels of detail. Types of formats for satellite data include HRIT/LRIT, HRPT/LRPT, WMO BUFR, McIDAS, NetCDF, HDF, XML, and the like. Typically a satellite begins collecting data the day it becomes operational and it usually continues collecting data at regular intervals until it has covered the entire surface of the earth (often more than once). It is a challenge to be able to use satellite data for different analytical purposes. At present, analysis of satellite data is most commonly performed using one or more proprietary tools which are only capable of analyzing or otherwise working with a limited dataset. As a result, it is not possible to do analysis on large scale time series of satellite data (e.g., satellite data for the past 10 years for an area), on demand.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings, in which:

FIG. 1 is a diagram illustrating a system for large scale analysis of satellite data in accordance with an example embodiment.

FIG. 2 is a diagram illustrating a method for analyzing satellite data in accordance with an example embodiment.

FIG. 3 is a diagram illustrating a method for analyzing satellite date in accordance with another example embodiment.

FIG. 4 is a diagram illustrating a device for analyzing satellite data in accordance with an example embodiment.

FIG. 5 is a diagram illustrating various types of data used for analyzing satellite data in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

Satellite data typically includes images of the earth as well as images of other features, objects, weather patterns, ozone, and the like. Once downloaded to a ground station or other database, satellite data is available in different formats, resolutions, level of detail, and the like. As a result, it can be challenging to use the satellite data for different analytical purposes. In most related systems, analysis of the satellite data is performed using proprietary tools and only on a limited dataset (e.g., a subset of data such as a yearly average, or a selected day or month in a year). In particular, related systems struggle to analyze satellite data because the volume of total available data is a challenge for tools such as ArcGIS or other types of custom proprietary tools. In order to combat this drawback, a small sample of interested data is input into the proprietary tool for analysis. However, when working with data from multiple satellites having multiple file formats, it is only possible to get a better understanding of satellite data, such as how trends have been moving on a general level, by analyzing large amounts satellite data, for example, terabytes of data or more.

The example embodiments are directed to a system and method for processing satellite data (e.g., large scale satellite data) collected by remote sensing satellites. The system and method herein are able to get scientific time series data from a satellite and map the data to a set of location/area on the Earth's surface. With this system a user is not limited to the amount of data and type of analysis that they can carry out. In addition, the system is able to scale horizontally by adding more storage and computing power thus being able to grow and handle the processing of time series data on a much larger scale than related proprietary tools. The system may extract satellite data from source data files at various satellite storage systems (e.g., NASA, NOAA, DMSP, NCEI, S-NPP, and the like). The source data files may have multiple formats. According to various aspects, the extraction process may convert the source data in multiple formats to satellite data having only one format. The satellite data can be processed to generate time series data for a geographical point of interest (e.g., region, point, area, polygon, and the like). Furthermore, additional analytics may be performed using large scale time series data (e.g., the last 15-20 years of data) for the point of interest which has not been possible before. The system is not limited by how much time series data needs processing. Furthermore, the system is not limited by tools or technology and the system can scale to add different formats of satellite data, and different amounts of satellite data (e.g., terabytes).

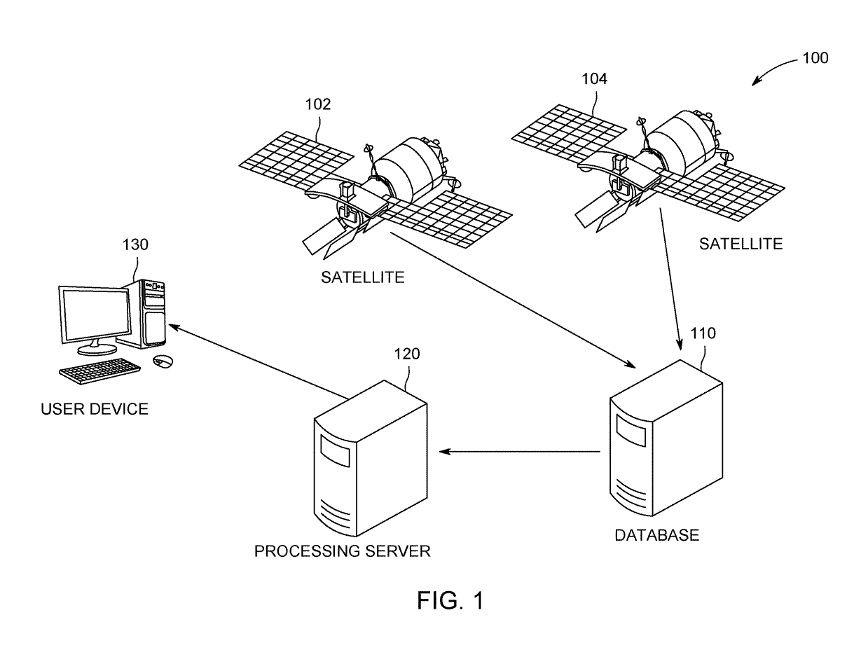

FIG. 1 illustrates a system 100 for large scale analysis of satellite data in accordance with an example embodiment. Referring to FIG. 1, the system 100 includes a plurality of satellites 102 and 104, a database 110, a processing server 120, and a user device 130. In this example, the satellites 102 and 104 may be orbiting the Earth and collect associated with the earth, atmosphere, ozone, oceans, and the like. For example, the satellites 102 and 104 may be geostationary, polar-orbiting, and the like. The data collected by the satellites 102 and 104 may include imaging data (e.g., infrared, visible, water vapor, etc.), and the like. The satellites 102 and 104 may transmit the data to various ground stations or databases such as database 110. In this example, one database 110 is shown but it should be appreciated that there may be a plurality of databases 110 including one or more databases for each satellite 102 and 104. The data collected by the satellite 102 and stored in the database 110 may have a first file format and the data collected by the satellite 104 and stored in the database 110 may have a second file format that is different than the first file format. For example, the first and second file formats may be one or more of HDF4, HDF5, NetCDF, TIFF, shape-files, text-files, and the like. That is, satellite data may be stored and available in multiple complex formats.

In the example embodiments, the system 100 may extract the data in multiple formats for a location or point of interest on the surface of the Earth surface or at a particular height above or below the Earth's surface, and perform complex analytics on the data. For example, analytical server 120 may download, extract, receive, or otherwise collect data of the satellites 102 and 104 from the source (e.g., database 110) where the data is stored. The data may be acquired over a network such as the Internet or a private network through FTP, a web portal, and the like. For most instruments onboard a satellite there is an algorithm for collecting data and resolution at which it captures the reading. The analytical server 120 may include a custom extractor to generate code for extracting data from a respective file format in which the data is available. The custom extractor may generate the extraction code differently based on the file format of the satellite data. Furthermore, regardless of the initial file format of the source data, the extracted data may be converted into one single format, for example, a comma separated value (CSV) format, and the like. Some file formats are very complex to handle and use for processing. By using a customizable extractor on the source data, the processing server 120 may acquire the data in a single format making it is easier for handling and processing.

The processing server 120 may identify spatial data and non-spatial data from the extracted satellite data. For example, the spatial data and the non-spatial data may be identified based on a format of the satellite data, a type of the satellite data, and the like. As described herein, the spatial data may be data related to a geographical position such as latitude and longitude coordinates, and the like. The non-spatial data may be related to any other types of data such as readings, sensor measurements, and the like, that may be associated with the corresponding geographical position. The processing server 120 may identify a point of interest from the spatial data by performing spatial analysis and mapping information for the non-spatial data based on the point of interest. The point of interest may be a geographical point, polygon, area, circle, and the like, and may be on the Earth's surface or below or above the surface. The point of interest may be received from a user, for example, via a request from user device 130. AS another example, the point of interest may be automatically detected by the processing server 120 such as in the case of an event, an anomaly, a weather pattern, and the like. The mapping information generated by the processing server 120 may be used to connect the spatial data and the non-spatial data. That is the mapping information may be a link between the spatial data and the non-spatial data. The mapping information may include, for example, a scan line, a pixel number, and the like, associated with a satellite. Accordingly, even though the spatial data and the non-spatial data are divided or separated during processing, the spatial data and the non-spatial data may be combined later by the processing server 120.

According to various embodiments, the processing server 120 may determine time series data corresponding to the point of interest from the non-spatial data based on the mapping information generated from the spatial data. The time series data may include large amounts of data (e.g., years of data gathered on a daily basis) from multiple satellites (e.g., satellites 102 and 104) for a point of interest. The time series data may include any type of time series data associated with satellite imagery or other types of satellite data/communications. The time series data may be used for analytical purposes such as weather forecasting, alert warnings, modeling of oceanic currents, and many countless other analytical operations. In this example, the processing server 120 may output the time series data to a user device 130 where it is displayed for a user. The user device 130 may include a computer, a laptop, a mobile device, a tablet, a server, and the like. Here, the processing server 120 and the user device 130 may be connected to each other over a wired or wireless network. As another example, the processing server 120 may include a user workstation or portal where a user can access and work on the time series data directly from the processing server 120 without a network communication of the time series data.

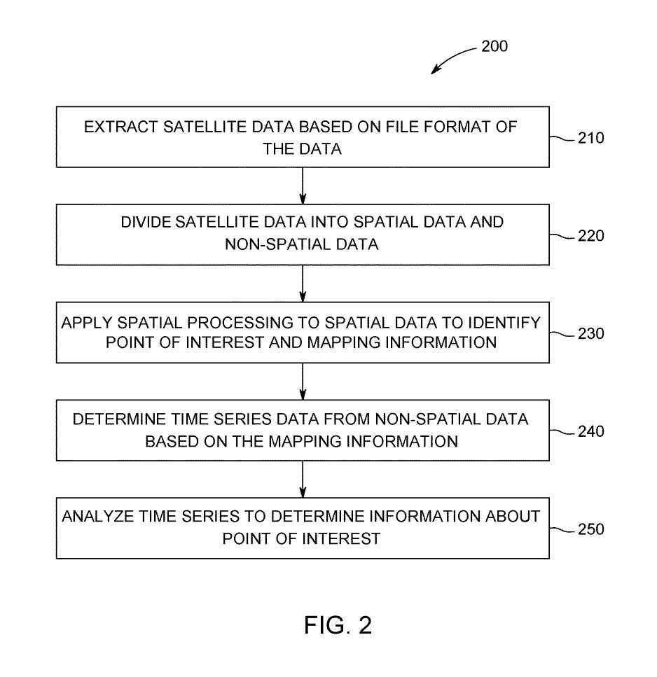

FIG. 2 illustrates a method 200 for analyzing satellite data in accordance with an example embodiment. For example, the method 200 may be performed by the processing server 120 shown in FIG. 1, or another device. Referring to FIG. 2, in 210 the method includes extracting satellite data from source files that comprise a plurality of file formats. For example, the source files may be from multiple satellites or from the same satellite having multiple instruments taking readings. In either case, the source files may include satellite data having a plurality of formats. The extracting in 210 may run a query on each source file and extract data based on a respective file format of the source file. The extracting may be performed on a plurality of source files. Furthermore, the extracted data having multiple initial formats may be converted or stored in a file having a single format making the data easier to work with and process.

In 220, the method includes identifying spatial data and non-spatial data from the satellite data. For example, an image taken from a satellite may have both spatial data (e.g., latitude and longitude coordinates, height, and the like), and may also have non-spatial data such as sensor data of the location (e.g., temperature, current, atmospheric conditions, pixel data, brightness, and the like). In some examples, the identifying in 220 may include segregating or dividing the spatial data and the non-spatial data within a storage file, dividing the data into separate files, extracting the data separately, or the like. In 230, the method includes applying spatial processing to the spatial data to identify a point of interest from the spatial data and also identify mapping information for the non-spatial data based on the point of interest. The point of interest may include a portion of a geographical area corresponding to the spatial data, and may have a shape of a point, a two-dimensional (2D) polygon, a three-dimensional (3D) object, and the like.

For example, the point of interest may be received from a user such as a user of user device 130 shown in FIG. 1, or a user of the analytical server 120. The point of interest may be identified from among satellite data of a larger geographical area associated with the spatial data. That is, the point of interest may be only a small geographical portion of the entire geographical area associated with the spatial data. As a result, the point of interest may reduce the amount of spatial data for further processing such that processing is only on the spatial data related to the point of interest. Furthermore, in 240 the method includes determining time series data corresponding to the point of interest from the non-spatial data based on the mapping information identified from the spatial data, and the time series data corresponding to the point of interest is analyzed to determine information about the point of interest, in 250. In some examples, in 250 the time series data may be displayed including some or all of the time series data determined for the point of interest. In addition, the information about the point of interest may include predictive analytics about weather, ocean currents, alerts, navigation, trend analysis, and the like.

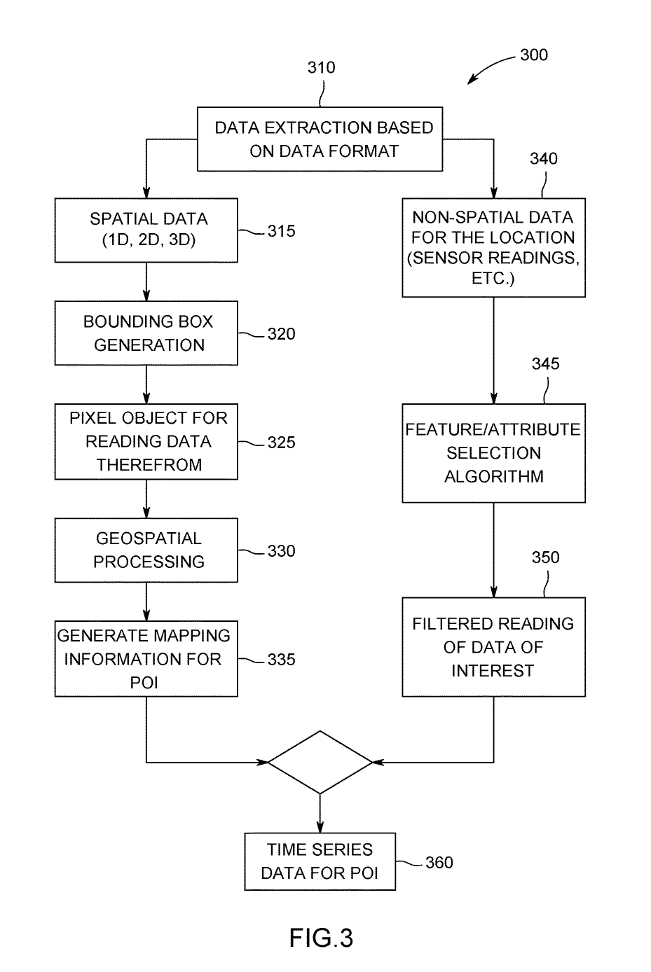

FIG. 3 illustrates a method 300 for analyzing satellite date in accordance with another example embodiment. For example, the method 300 may be performed by the processing server 120 shown in FIG. 1, or another device. In the example of the method 300 of FIG. 3, satellite data is segregated into two types of data and written out in a custom format for processing. For example, the custom format may be a comma separated values format, a generic format, and the like. In this example, the satellite data is extracted from source files having multiple formats and stored in a generic file having a single format in 310. Next, the data is divided into spatial data in 315 or non-spatial data in 340. For example, the spatial data may be pixel object data having a one-dimensional (1D), two-dimensional (2D), or three-dimensional (3D) format, and the non-spatial data may be a feature set associated with a location of the spatial data. For example, the feature set may include sensor readings, measurements, and the like.

In the left half of the method 300, the spatial data is processed. In particular, the spatial data from 315 may be processed using a database and program suited for spatial data processing. For example, the spatial data processing may be performed using geo-spatial software system and/or libraries on the 1D, 2D or 3D spatial object. In order to speed up geo-spatial processing and avoid needing additional processing stages the system may use 2D geometry in 320. For example, a determination may be made as to whether the spatial data has a 2D geometry associated with it. In this case, if the satellite data does not have a 2D geometry as part of the data, in 320 the system generates a 2D geometry using a bounding box generation algorithm. We carry many optimizations for processing the large amount of spatial data (order of billion records for each dataset).

Based on the bounding box in 320 (either predefined or dynamically generated) the pixel object data is read in 325 and geospatial processing is performed on the pixel object data in 330 based on a point of interest that may be received from a user. For example, the geospatial processing in 330 may query the data for a set of locations (point of interest) and generate mappings for the entire time series data in 335. For example, the mapping information may be generated by applying a geospatial operation on the spatial data and applying complex spatial analytics to generate the mapping information. The entire time series data includes an accumulation of time series data over a large scale of time, for example, years, decades, and the like. The mapping information for a location may identify an accumulation of pixels that fall within the time series data of the point of interest (i.e., pixels associated with the location of the point of interest over a predetermined period of time). Furthermore, the mapping information identifies a link between the spatial data and the non-spatial data. Then we merge, process, sample, statistical, etc. This will reduce the amount of time series data to the point of interest.

In 345, the method includes using the mapping information generated by the spatial processing on the pixel object in 335 to extract a feature set from the non-spatial data in 340. In this example, the feature set is time series data associated with the point of interest. Non-spatial data is also referred to as a feature set and may be generated by applying filters on the dataset in 345. In 350, a cleanup process can be performed on time series data to get rid of void/bad data and also trim the fields to only the required or fields of interest. According to various aspects, the mapping information connects the spatial data and non-spatial data. The mapping information is combined with the non-spatial data (feature set) to generate preliminary time series data for the point of interest in 360. In addition, transformation, aggregations, pre-calculations, and the like, can be performed on the time series data for the point of interest. The generated time series data may be used for predictive modelling purposes. As another example, trend analysis and advanced analytics may be performed using the time series data.

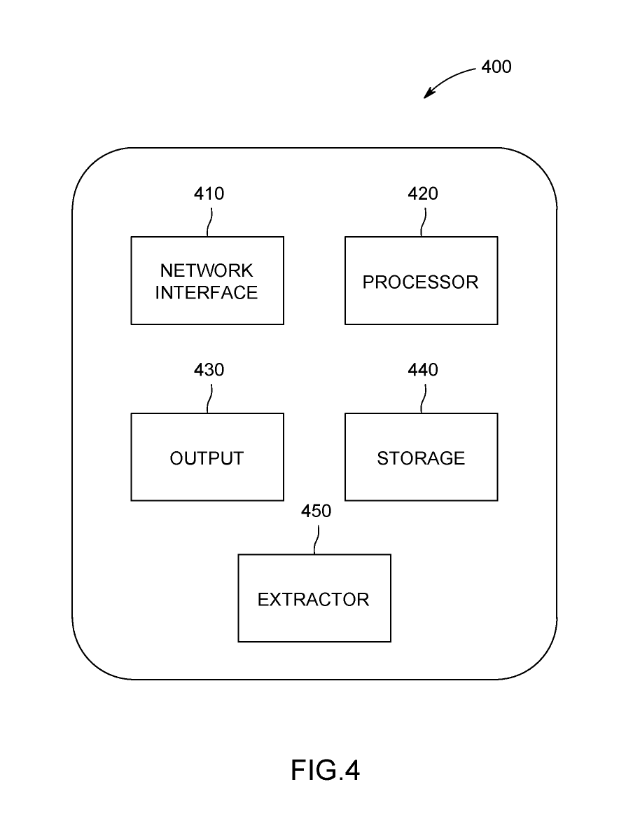

FIG. 4 illustrates a device 400 for analyzing satellite data in accordance with an example embodiment. For example, the device 400 may correspond to the processing server 120 shown in FIG. 1, and may be capable of performing the method 200 of FIG. 2 and/or the method 300 of FIG. 3. Referring to FIG. 4, the device 400 may process satellite data and may include a network interface 410, a processor 420, an output 430, a storage 440, and an extractor 450. The network interface 410 may transmit and receive data over a network such as the Internet or a private network. The processor 420 may include one or more processing devices each including one or more processing cores. The processor 420 may control the overall operations of the device 400. The output 430 may output data such as a user interface to a display such as an embedded display (e.g., a touch screen on a mobile device or an external display attached to the device through a connection such as a wired or wireless connection). The storage 440 may include any desired memory, for example, random access memory (RAM), one or more hard disks, cache, hybrid memory, an external memory, flash memory, and the like.

According to various embodiments, the extractor 450 may extract satellite data from source files that comprise a plurality of file formats. For example, the extractor 450 may query the source files and extract some data while not extracting other data. In some examples, the extractor 450 may store the extracted data in a single file format instead of multiple file formats. In this case, the plurality of file formats may include at least two of HDF, NetCDF, TIFF, and ShapeFile, and the single file format may include CSV, or the like. The storage 440 may store the extracted data having the single file format or having multiple file formats. The processor 420 may identify spatial data and non-spatial data from the extracted satellite data, and identify a point of interest from the spatial data.

Furthermore, the processor 420 may identify the point of interest by identifying a plurality of pixels corresponding to a geographical area of interest from satellite data. For example, an identification of the point of interest (e.g., text input) may be received from a user of the device 400 or an external device connected to the device 400 via the network interface 410. As another example, the point of interest may be automatically detected based on an event or some other anomaly in the satellite data. The geographical area may be a point on a map, a polygon, a circle, a 3D object, or the like. For example, the processor 420 may identify the point of interest by identifying a plurality of pixels corresponding to a geographical area of interest The processor 420 may also identify mapping information for the non-spatial data based on the spatial data. The mapping information may link the spatial data and the non-spatial data at the point of interest. For example, the mapping information may include at least one of a scan line and a pixel number corresponding to a satellite that is common between the spatial data and the non-spatial data. Furthermore, the processor 420 may determine time series data corresponding to the point of interest from the non-spatial data based on the mapping information identified from the spatial data. The output 430 may display the time series data corresponding to the point of interest on a display device.

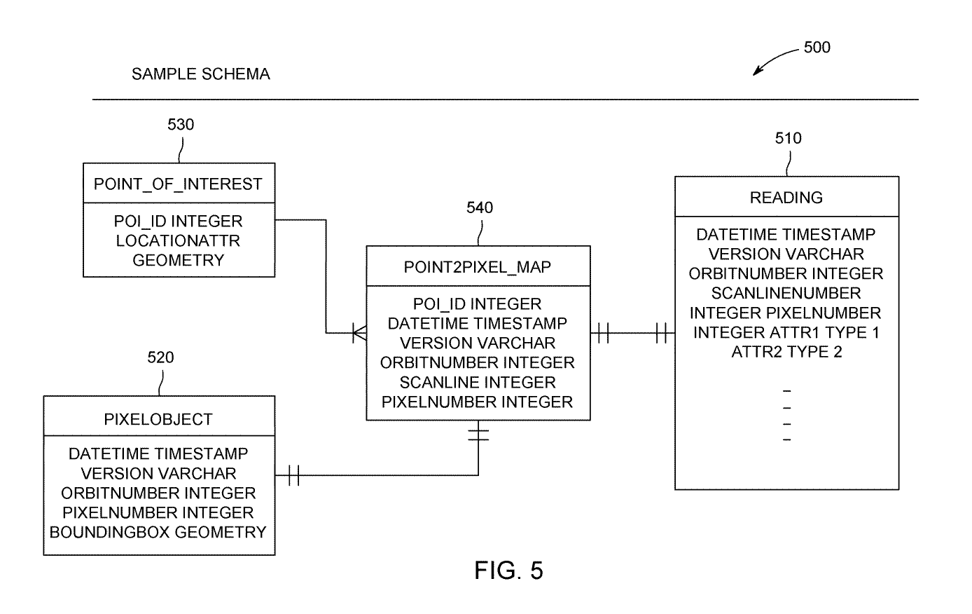

FIG. 5 illustrates examples of satellite data structures in accordance with an example embodiment. Referring to FIG. 5, four types of data are represented in the sample schema 500 and they include a reading 510, a pixel object 520, a point of interest 530, and a point2pixel map 540. In this example, the reading 510 includes a table or collection of scientific data (e.g., feature set) that is collected by a satellite or multiple satellites. The reading 510 includes a few extra fields which are generated along with the feature data, for example, experimental fields and quality flags. The pixel object 520 includes the pixel object of the satellite reading. For example, the object can be a 1-D, 2-D, or 3-D object such as a point, a polygon, an area of 3-D shape in atmosphere, and the like. The pixel object 520 has associated scientific data readings which are collected by different sensors onboard a satellite. The pixel object 520 may be a primary table which is used for generating mapping information to the non-spatial data. The pixel object 520 is kept separate from the other non-spatial attribute which is multi fold in size. Also, optimizations may be performed on data to improve the performance of spatial query on the large data. For example, a spatial operation may be run on billions of spatial records.

The point of interest 530 is the geographical location of interest such as the location of a gas turbine, an airport, an oil and gas field, an oceanic station, and the like. The point2pixel map 540 includes mapping information of a point of interest location against the pixel object of the satellite. This table is an optimization layer that performs spatial computation to locate which readings are associated with a point of interest for the time series data.

One of the benefits of the system and method described herein, is the ability to store and process large amounts (TBs) of satellite data while also providing the ability to do complex spatial analysis on the data. As a result, it is possible to use the satellite data in the most flexible way and apply analytical techniques on the data for industrial advantage. The time series data may be used to build predictive modelling and may be applicable to multiple domains in which it is important to understand the impact of external factors to machine operations.

In one testing example, a Hadoop YARN cluster was used to store the non-spatial data and an MPP based RDBMS (EMC Greenplum) was used to store the spatial data and perform computation. However, the examples are not limited thereto. The data storage was partitioned across the cluster in a way that could utilize the processing technology efficiently. Compression was also applied to the data stored on both type of systems in order to reduce the amount of disk space and also to improve performance of system. This system works even if the data is not gridded because it can generate the time-series data for the location.

Satellites have been operational for many decades now and have been collecting data on a regular basis, for example, daily, weekly, monthly, and the like. Scientist have always been looking at the data and deriving new findings/analysis but there has been a recent bottleneck in the ability to analyze time series data associated with a point of interest due to the amount of data and complexity. According to various embodiments, provided is a processing system and set of methods which cater to this problem. The example embodiments provide the ability to use time series data on a large scale from satellites without losing granularity and confidence of scientific process. For example, the system provides users the ability to pick a granularity of satellite data for use with analysis and also allows the user the option to use the all historic data for any location (e.g., hourly data for the last 15 years of the satellite).

According to various embodiments, the system may extract satellite data having multiple formats and convert the satellite data into one single format making the data easier to work with. Furthermore, the satellite data can be divided into spatial and non-spatial data. The spatial data can be used to identify a point of interest such as a geographical location, and also generate mapping information for the point of interest that connects the spatial data to the non-spatial data by the location. Based on the mapping information, the system can detect time series data from the non-spatial data and generate a feature set for the point of interest. Additional embodiments include performing analysis, operations, calculations, predictions, and the like on the time series data for the point of interest to determine information or make predictions about the point of interest.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing device for processing satellite data, the computing device comprising:
an extractor configured to extract satellite data from source files that comprise a plurality of file formats;
a processor configured to identify spatial data and non-spatial data from the extracted satellite data, identify a point of interest of the spatial data and mapping information between the spatial data and the non-spatial data corresponding to the point of interest, and determine time series data for the point of interest from the non-spatial data based on the mapping information identified from the spatial data; and
an output configured to display the time series data corresponding to the point of interest.

2. The computing device of claim 1, wherein the extractor is configured to convert the satellite data from the plurality of file formats into one file format.

3. The computing device of claim 2, wherein the plurality of file formats comprise at least two of HDF, NetCDF, TIFF, and ShapeFile, and the one file format comprises CSV.

4. The computing device of claim 1, wherein the mapping information comprises at least one of a scan line and a pixel number corresponding to a satellite.

5. The computing device of claim 1, wherein the processor identifies the point of interest by identifying a plurality of pixels corresponding to a geographical area of interest.

6. The computing device of claim 1, wherein the point of interest comprises only a portion of a geographical area corresponding to the spatial data, and the point of interest has a shape of at least one of a point, a two-dimensional (2D) polygon, and a three-dimensional (3D) object.

7. The computing device of claim 1, further comprising a network interface configured to receive an identification of the point of interest from a user device.

8. A method for processing satellite data, the method comprising:
extracting satellite data from source files that comprise a plurality of file formats;
identifying spatial data and non-spatial data from the extracted satellite data;
identifying a point of interest of the spatial data and mapping information between the spatial data and the non-spatial data corresponding to the point of interest;
determining time series data for the point of interest from the non-spatial data based on the mapping information identified from the spatial data; and
displaying the time series data corresponding to the point of interest.

9. The method of claim 8, wherein the extracting converts the satellite data from the plurality of file formats into one file format.

10. The method of claim 9, wherein the plurality of file formats comprise at least two of HDF, NetCDF, TIFF, and ShapeFile, and the one file format comprises CSV.

11. The method of claim 8, wherein the mapping information comprises at least one of a scan line and a pixel number corresponding to a satellite.

12. The method of claim 8, wherein the identifying the point of interest comprises identifying a plurality of pixels corresponding to a geographical area of interest.

13. The method of claim 8, wherein the point of interest comprises only a portion of a geographical area corresponding to the spatial data, and the point of interest has a shape of at least one of a point, a two-dimensional (2D) polygon, and a three-dimensional (3D) object.

14. The method of claim 8, further comprising receiving an identification of the point of interest from a user device.

15. A non-transitory computer readable medium having stored therein instructions that when executed cause a computer to perform a method for processing satellite data, the method comprising:
extracting satellite data from source files that comprise a plurality of file formats;
identifying spatial data and non-spatial data from the extracted satellite data;
identifying a point of interest of the spatial data and mapping information between the spatial data and the non-spatial data corresponding to the point of interest;
determining time series data for the point of interest from the non-spatial data based on the mapping information identified from the spatial data; and
displaying the time series data corresponding to the point of interest.

16. The non-transitory computer readable medium of claim 15, wherein the extracting converts the satellite data from the plurality of file formats into one file format.

17. The non-transitory computer readable medium of claim 16, wherein the plurality of file formats comprise at least two of HDF, NetCDF, TIFF, and ShapeFile, and the one file format comprises CSV.

18. The non-transitory computer readable medium of claim 15, wherein the mapping information comprises at least one of a scan line and a pixel number corresponding to a satellite.

19. The non-transitory computer readable medium of claim 15, wherein the identifying the point of interest comprises identifying a plurality of pixels corresponding to a geographical area of interest.

20. The non-transitory computer readable medium of claim 15, wherein the method further comprises receiving an identification of the point of interest from a user device.
